(19) United States
(12) Patent Application Publication
(10) Pub. No.: US 2011/0065300 A1
(43) Pub. Date: Mar. 17, 2011

(54) FLOATING CONNECTOR

(75) Inventors: Kotaro Kobayashi, Kanagawa (JP); Naoya Matsuura, Kanagawa (JP)

(73) Assignee: Molex Incorporated, Lisle, IL (US)

(21) Appl. No.: 12/991,799

(22) PCT Filed: May 11, 2009
(86) PCT No.: PCT/US09/43402

§ 371 Date: Nov. 9, 2010

(30) Foreign Application Priority Data
May 9, 2008 (JP) 2008-123072

(51) Int. Cl. H01R 13/64

(52) U.S. Cl. 439/248

(57) ABSTRACT

A floating connector 1 according to the present invention has a housing 2, and an adapter 3 having a through-hole 31 into which the housing 2 is inserted. The housing 2 includes: a first projection portion 27 that projects laterally outward and abuts against a periphery of an opening of the through-hole 31 to regulate a movement in an insertion direction; and a second projection portion 29 that is inserted into the through-hole 31 to regulate a movement in a direction opposite to the insertion direction with a stopper portion 39 which is disposed within the through-hole 31.

### BACKGROUND OF THE PRESENT INVENTION

1. Field of the Present Invention

The Present Invention relates, generally, to a floating connector, and, more particularly, to a two-piece floating connector capable of compacting the reach range of the floating members.

2. Description of the Related Art

An example of a conventional floating connector is disclosed in Japanese Utility Model Application Laid-Open No. HEI 7-18356, and represented at FIG. 11b. Typically, conventional floating connectors have a rotating portion larger in diameter than a housing, disposed on the back side thereof. The rotating portion is floatably supported within a connector insertion hole formed in a panel. Further, a plate spring radially extends from the rotating portion, and a retainer plate is positioned on a back side of the rotating portion, are disposed. Finally, the panel is sandwiched between those members to support the rotating portion.

However, in the conventional floating connector, the plate spring and the retainer plate, disposed so that the rotating portion does not fall out of the connector insertion hole, are floated together with the housing. Therefore, a reach range of the floating member becomes necessarily enlarged. When the reach range of the floating members is enlarged, it is difficult to arrange a plurality of floating connectors in proximity to each other.

### SUMMARY OF THE PRESENT INVENTION

The Present Invention has been developed in view of the above circumstances, and therefore, one object is to provide a floating connector which is capable of compacting the reach range of the floating members. To solve the above-stated disadvantages, the Present Invention provides a floating connector having a housing; an adapter having a through-hole into which the housing is inserted; a first projection portion projecting laterally outward and abuting against a periphery of an opening of the through-hole to regulate a movement in an insertion direction; and a second projection portion inserted into the through-hole to regulate a movement in a direction opposite to the insertion direction with a stopper portion also disposed within the through-hole.

The Present Invention further provides a floating connector including a housing having a concave portion formed on a front surface for housing a counterpart connector and an insertion hole formed on a rear surface for inserting a terminal connected to the counterpart connector. The housing includes a first projection portion that projects laterally outward from the concave portion side; a second projection portion that projects laterally outward from the insertion hole side; an outer edge positioned inward of the first projection portion; and an adapter that houses the housing. The housing is formed with a through-hole that extends from the front surface side toward the rear surface side in which the second projection portion is inserted from an opening on a front surface side of the through-hole. The front surface of a periphery of the opening abuts against a rear surface of the first projection portion to regulate a movement in an insertion direction. The adapter includes a stopper portion abutting against a front surface of the second projection portion to regulate a movement in an opposite direction to the insertion direction.

According to the Present Invention, a main portion of the housing (i.e., the portions that are thinner than the first and second projection portions) can float within the through-hole of the adapter. Further, the first and second projection portions are used as retainers with respect to the adapter. Therefore, the Present Invention is capable of suppressing the length of the floating members which project laterally, thereby enabling the reach range of the floating members to be compacted as compared with a configuration in which the plate spring and the retainer plate for sandwiching the panel extend radially from the rotating portion in order to floatably support the rotating portion that is larger in diameter than the housing within the connector insertion hole of the panel as in the conventional floating connector.

According to an aspect of the Present Invention, the insertion hole side of the housing is thinner than the concave portion side, and the stopper portion of the adapter is arranged laterally outward of the insertion hole side of the housing. As a result, since the stopper portion, which abuts against the front surface of the second projection portion, can be arranged more inwardly, the adapter can be compacted.

According to an aspect of the Present Invention, the adapter includes projection portions, a part of an outer side surface of which projects laterally outward of other parts, which have opposed surfaces directed toward a front or rear surface side. The adapter is fitted to the panel in a state where a front surface of a periphery of a mounting opening, which is defined in the panel, faces the opposed surfaces. A peripheral edge of the mounting opening reaches a base end side of the projection portions. As a result, when an external force is applied to the adapter in the insertion direction or its opposite direction, the opposed surfaces of the projection portions abut against the front surface of the panel, thereby enabling the movement of the adapter to be regulated. Further, because the peripheral edge of the mounting opening of the panel reaches the base end side of the projection portions, a stress that is generated at the base end side of the projection portions can be reduced, thereby effectively preventing damage as compared with a configuration in which the stress that is applied from the panel is exerted on only a leading end side of the projection portions.

According to an aspect of the Present Invention, the rear surface of the first projection portion of the housing, and the front surface of a periphery of the opening of the adapter which faces the rear surface, are formed with a protrusion on one of the front surface and the rear surface, and a hole portion that is larger laterally than the protrusion, into which the protrusion is inserted, on another one of the front surface and the rear surface, and a lateral movement of the housing, is regulated when the protrusion abuts against an inner wall of the hole portion. Thus, a floating amount of the housing can be defined by the projection portion and the hole portion.

According to an aspect of the Present Invention, at least a part of the front surface side of the concave portion which is formed in the housing spreads toward the front surface side up to a region including at least a part of a base end side of the first projection portion. As a result, the spread of the concave portion on the front surface side can be increased by using a region where the first projection portion projects.

### BRIEF DESCRIPTION OF THE FIGURES

The organization and manner of the structure and operation of the Present Invention, together with further objects and advantages thereof, may best be understood by reference to the following Detailed Description, taken in connection with the accompanying Figures, wherein like reference numerals identify like elements, and in which:

FIG. 1 is a perspective view showing a floating connector according to an embodiment of the Present Invention;

FIG. 2 is a perspective view of the floating connector, shown fitted to a panel;

FIG. 3A is a perspective view of the flowing connector, showing a housing according to an embodiment of the Present Invention;

FIG. 3B is a front view of the housing;

FIG. 3C is a rear view of the housing;

FIG. 3D is a cross-sectional view of the housing;

FIG. 4A is a perspective view of the floating connector, showing an adapter according to the embodiment of the Present Invention;

FIG. 4B is a front view of the adapter;

FIG. 4C is a rear view of the adapter;

FIG. 4D is a cross-sectional view of the adapter;

FIG. 4E is a side view of the adapter;

FIG. 4F is a side view of the adapter;

FIG. 5A is an explanatory diagram related to the assembly of the housing and the adapter;

FIG. 5B is an explanatory diagram related to the assembly of the housing and the adapter;

FIG. 6A is a perspective view of the panel of the floating connector;

FIG. 6B is a front view of the panel;

FIG. 7A is an explanatory diagram related to the assembly of the floating connector and the panel;

FIG. 7B is an explanatory diagram related to the assembly of the floating connector and the panel;

FIG. 7C is an explanatory diagram related to the assembly of the floating connector and the panel;

FIG. 8 is a diagram showing a region where the adapter abuts against a front surface of the panel;

FIG. 9A is a partially enlarged cross-sectional view showing the region where the adapter abuts against the front surface of the panel;

FIG. 9B is a partially enlarged cross-sectional view showing the region where the adapter abuts against the front surface of the panel;

FIG. 10 is a partially enlarged cross-sectional view showing a front surface side of a concave portion defined in the housing;

FIG. 11A is a diagram for explaining the advantages of the Present Invention; and

FIG. 11B is a diagram for explaining the conventional art.

### DESCRIPTION OF THE PREFERRED EMBODIMENTS

While the Present Invention may be susceptible to embodiment in different forms, there is shown in the Figures, and will be described herein in detail, specific embodiments, with the understanding that the disclosure is to be considered an exemplification of the principles of the Present Invention, and is not intended to limit the Present Invention to that illustrated.

In the embodiments illustrated in the Figures, representations of directions such as up, down, left, right, front, rear and the like, used for explaining the structure and movement of the various elements of the Present Invention, are not absolute, but relative. These representations are appropriate when the elements are in the position shown in the Figures. If the description of the position changes, it is presumed that these representations are to be changed accordingly.

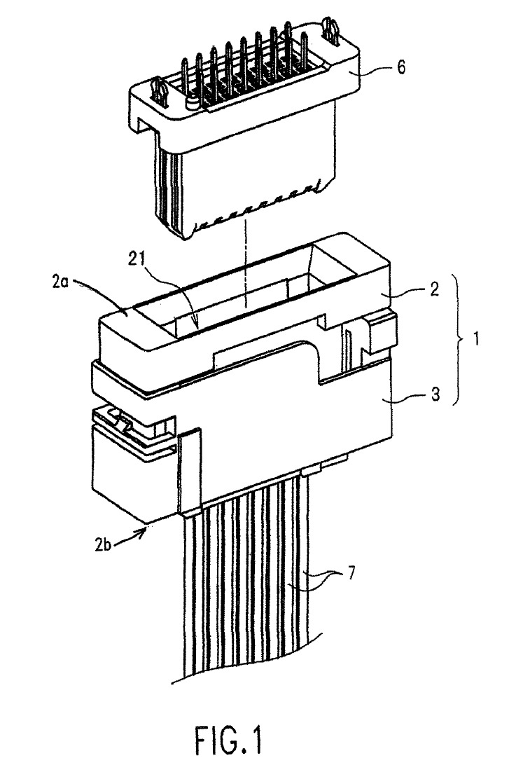

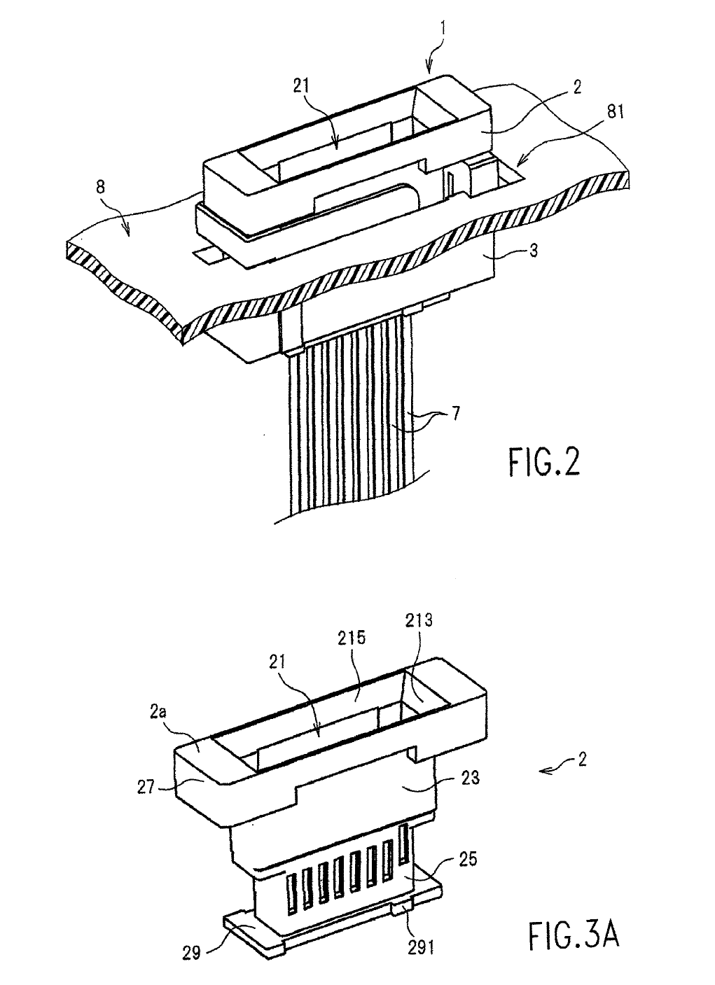

Referring to FIGS. 1-2, floating connector 1 is illustrated as fitted to panel 8. In this embodiment, the vertical direction of floating connector 1 corresponds to the vertical direction of FIGS. 1-2. Further, the upside of floating connector 1 is called the “front surface side,” while the downside is called the “rear surface side.”

Floating connector 1 is preferably configured as a female connector of a substantially rectangular configuration, in which housing 2 and adapter 3, which are made of an insulating material, are combined together. Concave portion 21, which houses counterpart male connector 6, is formed on front surface 2a of housing 2. Also, terminals (not shown), which are crimped to the leading ends of cables 7, are inserted from rear surface 2b side of housing 2 and electrically connected to terminals that are disposed on counterpart male connector 6, which is housed in concave portion 21. On the other hand, adapter 3 is fixed to the peripheral edge of mounting opening 81, defined in panel 8, and floatably supports housing 2, that has been housed by adapter 3 in an in-plane direction (i.e., a direction orthogonal to the vertical direction) of panel 8.

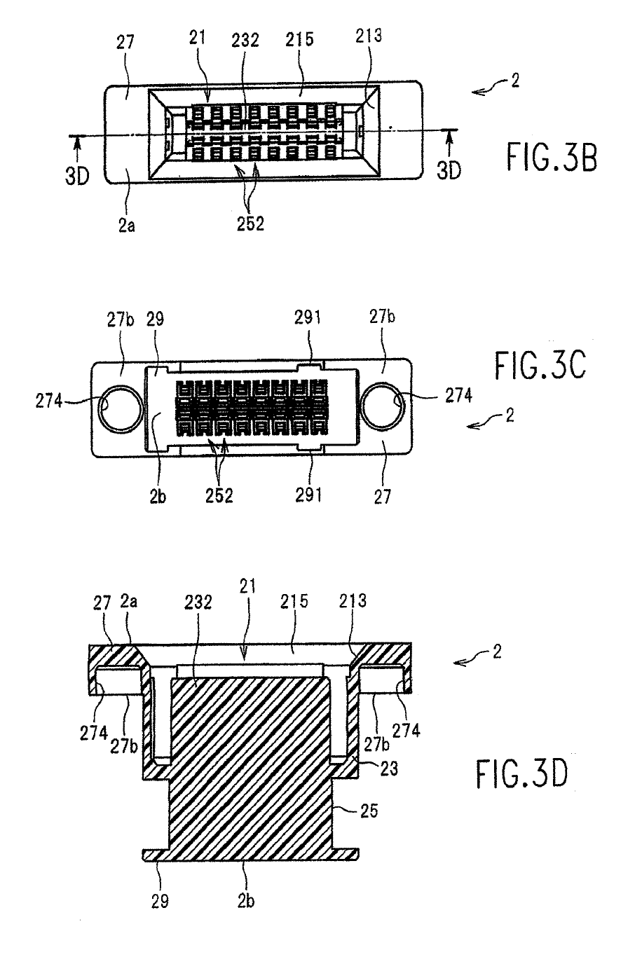

Referring to FIGS. 3A-D, front surface 2a of housing 2 is formed with concave portion 21 recessed downward from front surface 2a. Counterpart male connector 6 is inserted into concave portion 21 downward from above. Also, tapered surfaces 213, 215, which spread upward, are formed on portions close to front surface 2a. Further, terminal insertion holes 252, which extend upward from rear surface 2b and communicate with the interior of concave portion 21, are formed on rear surface 2b of housing 2. The terminals that are crimped to the leading ends of cables 7 are inserted into terminal insertion holes 252 upward from below. Also, partition portion 232, for partitioning the terminals that reach the interior of concave portion 21, from terminal insertion hole 252 rises upward from a bottom portion within concave portion 21.

In this embodiment, terminal insertion holes 252 are preferably arranged in a plurality of lines. Consequently, concave portion 21 is spread along a direction in which the lines of terminal insertion holes 252 extend (i.e., a direction along which a large number of terminal insertion holes 252 are arranged). Also, housing 2 preferably has a configuration that extends in that direction as a whole. Hereinafter, that direction is called the “longitudinal direction.” Further, a direction along which the lines of terminal insertion holes 252 are arranged (i.e., a direction along which a small number of terminal insertion holes 252 are arranged) is called the “lateral direction.”

In housing 2, front side main body portion 23 of a substantially rectangular configuration in which concave portion 21 is defined, and rear side main body portion 25 of a substantially rectangular configuration smaller than front side main body portion 23 in width in both of the longitudinal direction and the lateral direction in which terminal insertion holes 252 are defined, are arranged in the vertical direction. Front side main body portion 23 is laterally larger than rear side main body portion 25 due to concave portion 21, into which counterpart male connector 6 is inserted is formed.

Further, housing 2 is formed with first projection portion 27 projecting laterally outward from the upper end of front side main body portion 23. First projection portion 27 largely projects toward both sides in the longitudinal direction, rather than the lateral direction, with respect to front side main body portion 23. Also, the front surface of first projection portion 27 forms front surface 2a, and both sides of first projection portion 27 in the longitudinal direction are formed with cylindrical hole portions 274 that extend upward from rear surface 27b.

Housing 2 is also formed with second projection portion 29 projecting laterally outward from the lower end of rear side main body portion 25. Second projection portion 29 largely projects toward both sides in the longitudinal direction, rather than the lateral direction, with respect to front side main body portion 23. Also, second projection portion 29 is formed such that the outer edges thereof are positioned inward of first projection portion 27. Further, a length that extends from a base portion to the outer edge is also smaller than that of first projection portion 27. In this embodiment, second projection portion 29 projects to the same degree as that of the outer side surface of front side main body portion 23. The rear surface of second projection portion 29 forms rear surface 2b of housing 2. Wrong insertion prevention keys 291, slightly extending laterally outward, are formed at positions that deviate from the center in the longitudinal direction on ends of second projection portion 29 in the lateral direction.

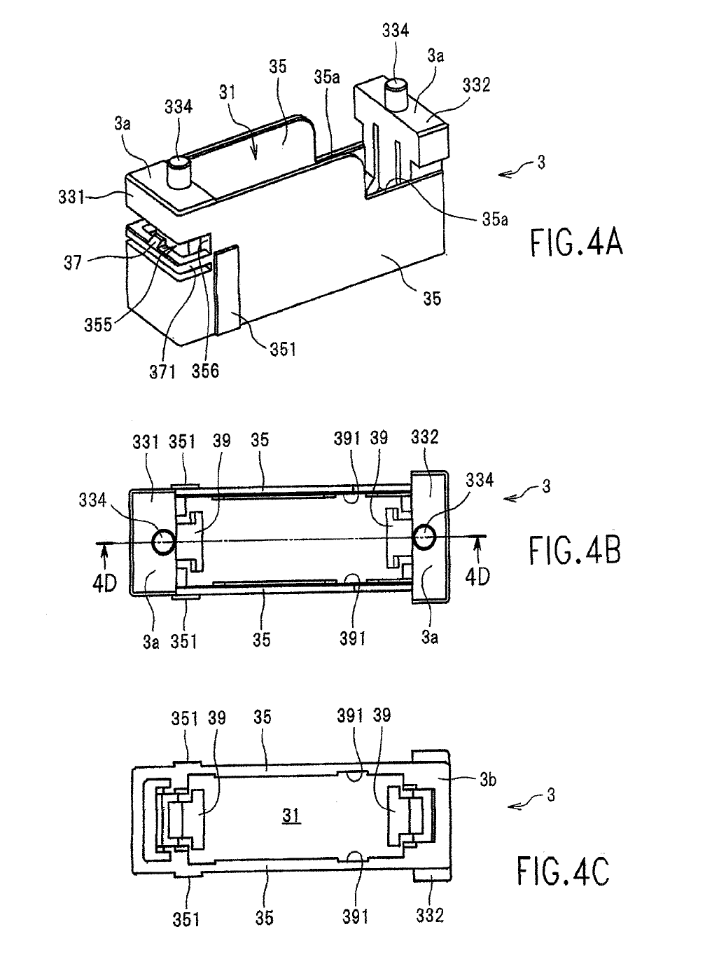

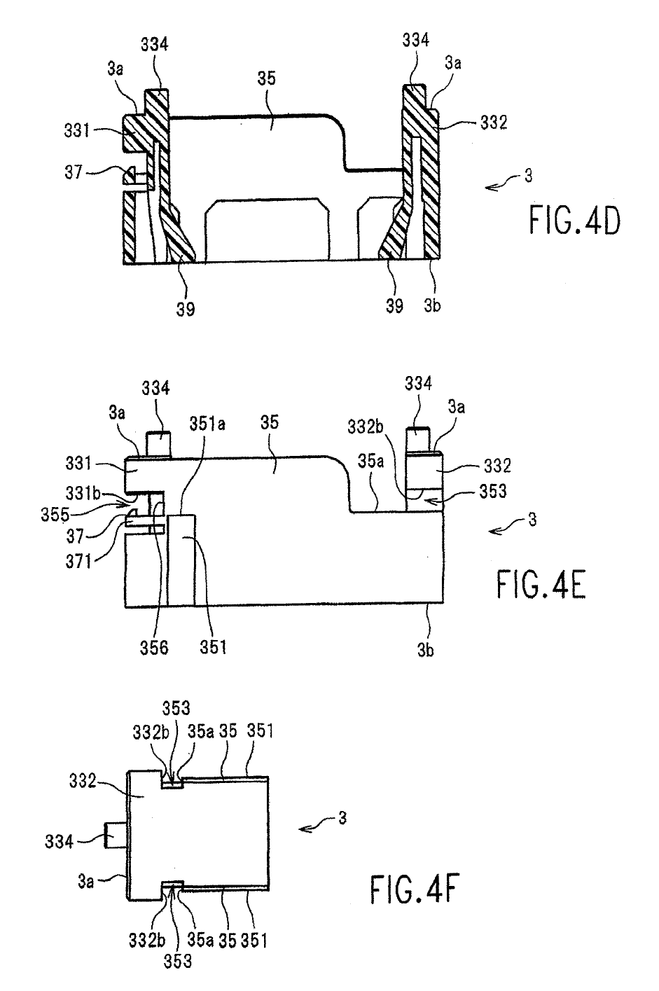

Referring to FIGS. 4A-F, adapter 3 preferably has a configuration of a substantially rectangular configuration, and is formed with through-hole 31 of a rectangular cross section which extends from front surface 3a to rear surface 3b. A portion of housing 2, which is lower than first projection portion 27, is inserted into through-hole 31. Through-hole 31 has such a configuration and size that second projection portion 29, rear side main body portion 25 and front side main body portion 23 of housing 2 can, and first projection portion 27 cannot, be inserted thereinto. Specifically, through-hole 31 is so set as to have the configuration and the size in which through-hole 31 is apart from the outer side surface of front side main body portion 23 of housing 2 by a length corresponding to a desired floating amount.

Thick portions 331, 332, which extend toward both sides in the longitudinal direction and are thickened in the vertical direction, are formed on front surface 3a of adapter 3 in communication with first projection portion 27 of housing 2. The front surfaces of thick portions 331, 332 form front surface 3a of adapter 3. Also, columnar protrusions 334, which extend upward and are inserted into cylindrical hole portions 274 formed in first projection portion 27 of housing 2, are formed on the front surfaces of thick portions 331, 332. Cylindrical hole portions 274 are also preferred to have configurations and sizes in which cylindrical hole portions 274 are apart laterally outward from the outer side surface of columnar protrusions 334 by a length corresponding to a desired floating amount.

Stopper portions 39, which extend downward from thick portions 331, 332 to an area of rear surface 3b, and whose lower ends are slightly bent toward the inner side, are formed in adapter 3. Also, wrong insertion prevention key grooves 391 that vertically extend are formed at positions corresponding to wrong insertion prevention keys 291 which are formed in second projection portion 29 of housing 2, on the inner surface of side wall portions 35, which are formed on both sides of adapter 3 in the lateral direction.

Preferably, the outer side surface of adapter 3 is so configured as to be engaged with panel 8. Specially, groove portion 355, which retreats inward in the longitudinal direction from the outer side surface of thick portion 331, and retreat surface 356 are formed below thick portion 331 formed on one side of adapter 3 in the longitudinal direction. That is, thick portion 331 is a projection portion that projects outward in the longitudinal direction from the bottom surface of groove portion 355 and has opposed surface 331b which is directed toward rear surface 3b. Further, thick portion 332, formed on another side of adapter 3 in the longitudinal direction, projects toward both sides in the lateral direction, and groove portions 353, which retreat inward in the lateral direction from the outer side surface of thick portion 332, are formed on both sides below thick portion 332. That is, thick portion 332 is a projection portion that projects outward in the lateral direction from the bottom surface of groove portion 353 and has opposed surfaces 332b directed toward rear surface 3b on both sides in the lateral direction.

Projection portions 351 are preferably slightly projected laterally outward and formed in the vicinity of thick portion 331 on the outer side surfaces of side wall portions 35 formed on both sides of adapter 3 in the lateral direction. Projection portions 351 have opposed surfaces 351a that are directed toward front surface 3a, respectively. Further, side wall portions 35, that are formed at both sides of adapter 3 in the lateral direction, are formed with portions whose upper ends are recessed downward in the vicinity of thick portion 332. The upper end surface of that portion is opposed surface 35a directed toward front surface 3a. Opposed surface 35a extend up to the lower side of thick portion 332.

Groove portions 353, 355 and opposed surfaces 331b, 332b, 351a, 35a can abut against the peripheral edge of mounting opening 81 when adapter 3 is fitted to panel 8. Also, engagement piece 37, for being engaged with panel 8, is elastically supported by the leading end of elastic support frame 371, which extends outward in the longitudinal direction from retreat surface 356 below thick portion 331 formed on one side of adapter 3.

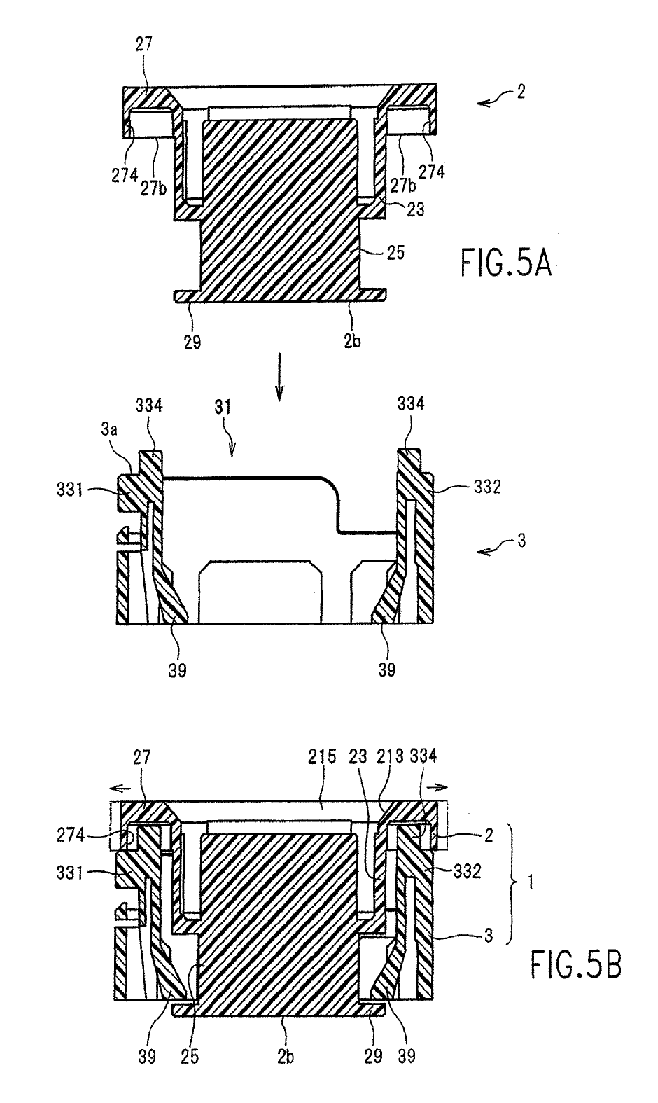

Referring to FIGS. 5A-B, housing 2 is inserted into through-hole 31 defined in adapter 3 from rear surface 2b. Specifically, second projection portion 29, rear side main body portion 25 and front side main body portion 23, which are smaller in width than through-hole 31, are inserted into through-hole 31. On the other hand, first projection portion 27, which is larger in width than through-hole 31, are not inserted into through-hole 31, and rear surface 27b abuts against front surfaces 3a of thick portions 331, 332. In this way, the movement of housing 2 in the insertion direction is regulated. Further, protrusions 334 formed on front surfaces 3a of thick portions 331, 332 of adapter 3 are inserted into hole portions 274 formed in rear surfaces 27b of first projection portion 27 when housing 2 is inserted into through-hole 31 of adapter 3.

Further, second projection portion 29 of housing 2 moves downward while pushing and widening stopper portions 39 outward, whose lower ends are slightly bent inward and which are arranged on both sides in the longitudinal direction, when housing 2 is inserted into insertion hole 31 of adapter 3. Then, when second projection portion 29 exceeds the lower ends of stopper portions 39, the pushed and widened stopper portions 39 return to an original position so as to abut against the front surface of second projection portion 29. Thus, the movement of housing 2 in the opposite direction (upward) of the insertion direction is regulated. Further, in this embodiment, a length that extends from front surfaces 3a of adapter 3 to the lower ends of stopper portions 39 in the vertical direction is comparable with a length between first and second projection portions 27, 29 in the vertical direction. With the above configuration, housing 2 does not move vertically.

Housing 2 and adapter 3 thus assembled together constitute floating connector 1 in which housing 2 is floatable laterally with respect to adapter 3 (i.e., in a direction orthogonal to the vertical direction). That is, the inner surface of through-hole 31 of adapter 3 surrounds the outer side surface of a portion disposed between first and second projection portions 27, 29 in housing 2, which are thinner than those portions; that is, the main body portion of housing 2 (front and rear side main body portions 23, 25) with a region that is laterally larger than the outer side surface. The main body portion of housing 2 is laterally movable inside through-hole 31.

Further, the inner walls of hole portions 274, which are defined in first projection portion 27 of housing 2, also surround the outer side surfaces of protrusions 334 of adapter 3, which are inserted into hole portions 274 with a region laterally larger than the outer side surfaces. Protrusions 334 are preferably laterally movable inside hole portions 274. In this embodiment, gaps defined between the outer side surfaces of protrusions 334 and the inner walls of hole portions 274 are set to be slightly smaller than gaps defined between the outer side surface of housing 2 and the inner surface of through-hole 31. Thus, the lateral movement of housing 2 is mainly regulated when protrusions 334 abut against the inner walls of hole portions 274.

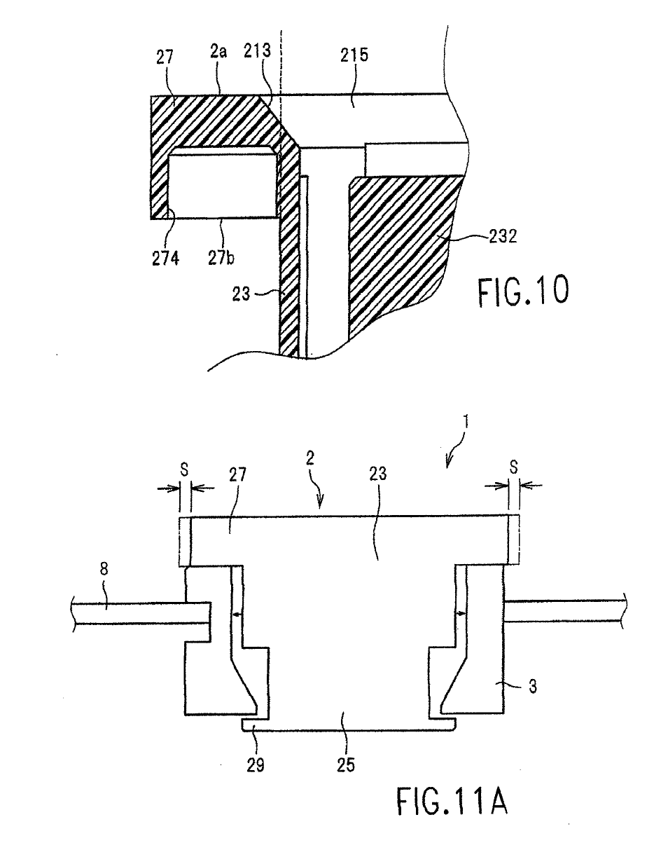

Further, tapered surfaces 213, 215 are formed on front surface 2a of concave portion 21 of housing 2. Therefore, even if counterpart male connector 6 is to be inserted into a position displaced from concave portion 21, counterpart male connector 6 abuts against tapered surfaces 213, 215, thereby making it possible to move housing 2 laterally so that concave portion 21 comes to the front side of counterpart male connector 6. Here, tapered surface 213 spreads in the longitudinal direction to a region including the base end portion of first projection portion 27 as shown in a partially enlarged cross sectional view of FIG. 10. That is, tapered surface 213 spreads toward first projection portion 27 over a line that extends from the outer side surface of front side main body portion 23. For that reason, a relatively large tapered surface 213 can be formed using the region in which first projection portion 27 is projected.

The terminals of cables 7 are inserted into terminal insertion holes 252 (referring to FIG. 3C) on rear surface 2b of housing 2 after housing 2 has been assembled with adapter 3. Alternatively, the terminals can be inserted into terminal insertion holes 252 after floating connector 1 has been fitted to panel 8, or the terminals have been inserted into housing 2 in advance, and housing 2 that is connected with cables 7 can be fitted to adapter 3 after adapter 3 has been fitted to panel 8.

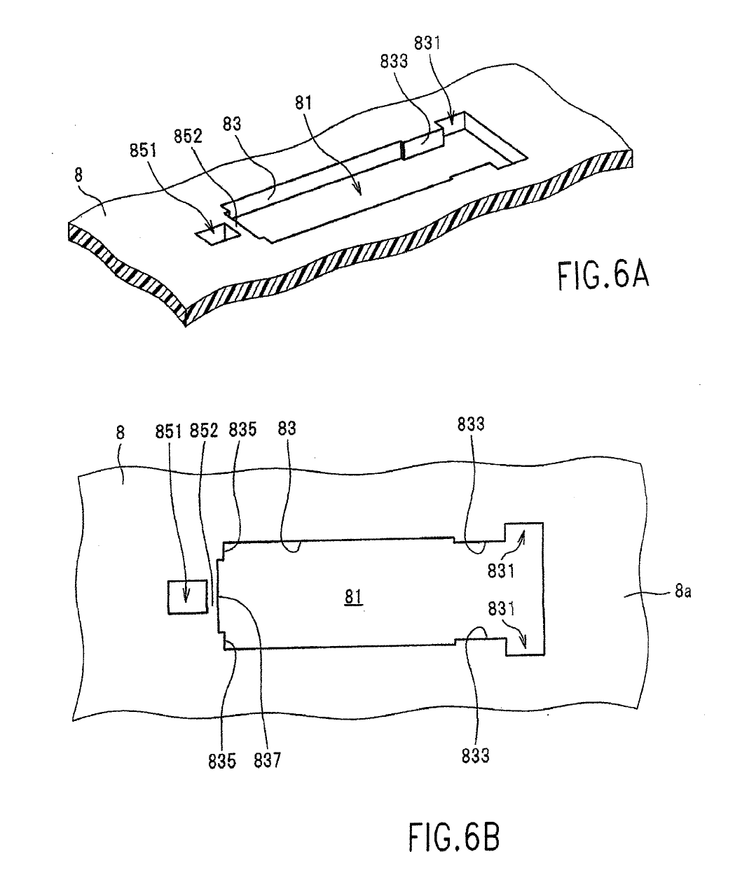

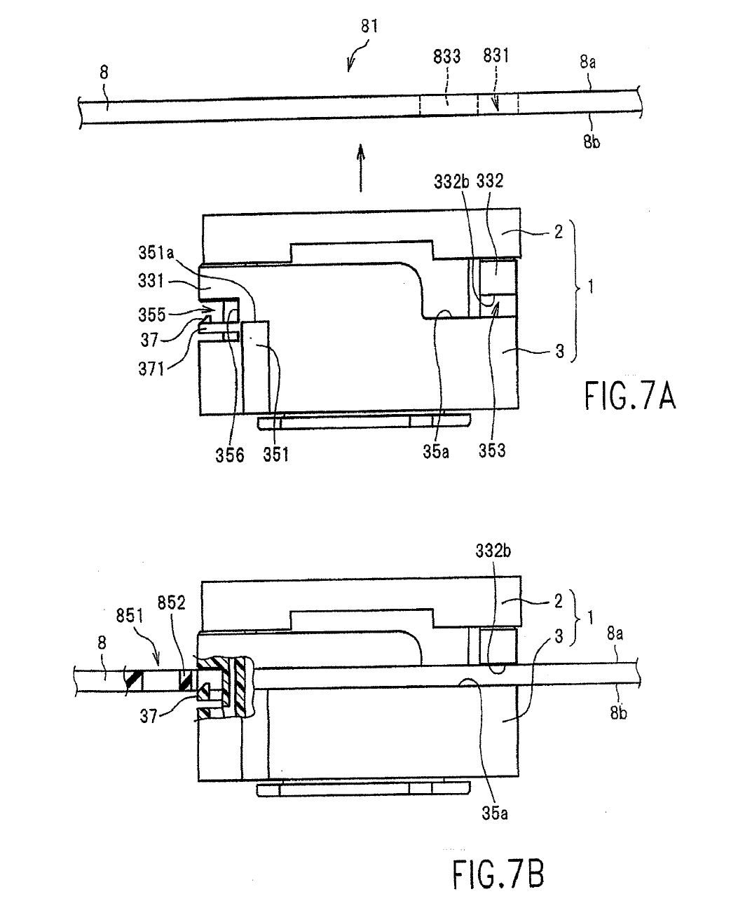

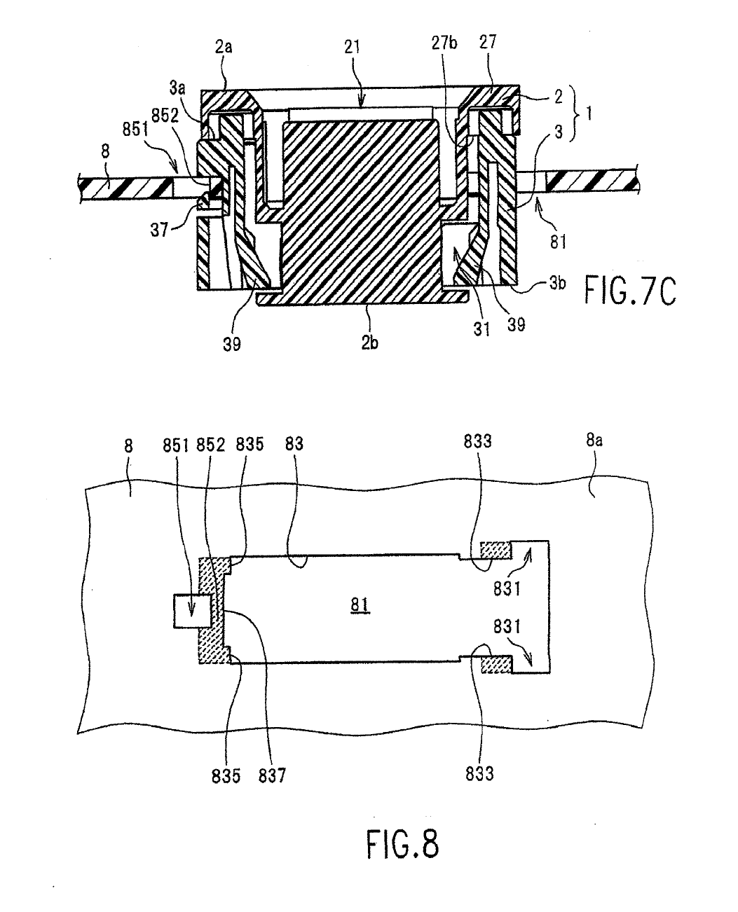

Referring to FIGS. 6-7, peripheral edge 83 of mounting opening 81, formed in panel 8, has a configuration corresponding to the contour (referring to FIG. 4B) of adapter 3 on front surface 3a so that floating connector 1 can be inserted into mounting opening 81. Specifically, one side of peripheral edge 83 in the longitudinal direction is formed with corresponding surfaces 835, 837, which are inserted into groove portion 355 formed below thick portion 331. Also, notch 851, vertically passing through panel 8, is defined in the vicinity of central corresponding surface 837. On the other hand, another side of peripheral edge 83 in the longitudinal direction is formed with insertion grooves 831 and opposed surfaces 833 corresponding to thick portion 332 and the vicinity thereof on both sides in the lateral direction.

As shown in FIG. 7A, floating connector 1 is inserted into mounting opening 81 from rear surface 8b of panel 8. In this situation, floating connector 1 is first inserted into mounting opening 81 from first projection portion 27 of housing 2. Also, in floating connector 1, thick portion 332 that projects toward the lateral direction of adapter 3 passes through insertion grooves 831 corresponding to thick portion 332, and is inserted into mounting opening 81.

Then, as shown in FIG. 7B, the movement of floating connector 1 into panel 8 in the insertion direction is regulated by abutting panel 8 against opposed surfaces 35a, 351a of adapter 3 when adapter 3 is inserted into panel 8 by a given amount subsequent to first projection portion 27 of housing 2. Thereafter, as shown in FIG. 7C, floating connector 1 is slid toward notch 851, and engagement piece 37 that is formed in adapter 3 is fitted to notch 851 that is formed in panel 8, and is engaged with engagement piece 852 that is formed between mounting opening 81 and notch 851. In this way, the lateral movement of floating connector 1 in the longitudinal direction is regulated. In this way, the fitting of floating connector 1 to panel 8 can be conducted by such simple operation that housing 2 and adapter 3 which have been assembled into one piece are inserted from rear surface 8b of panel 8, and laterally slid.

Also, thick portions 331, 332 of adapter 3 run on front surface 8a of panel 8 in a state where floating connector 1 is engaged with panel 8. That is, rear surfaces 331b, 332b of thick portions 331, 332 of adapter 3 face front surface 8a of panel 8. The opposed region in this situation is shown in FIG. 8. In this way, rear surfaces 331b, 332b of thick portions 331, 332 of adapter 3 abut against front surface 8a of panel 8, thereby regulating the movement of floating connector 1 in a direction opposite to the insertion direction (downward) into panel 8.

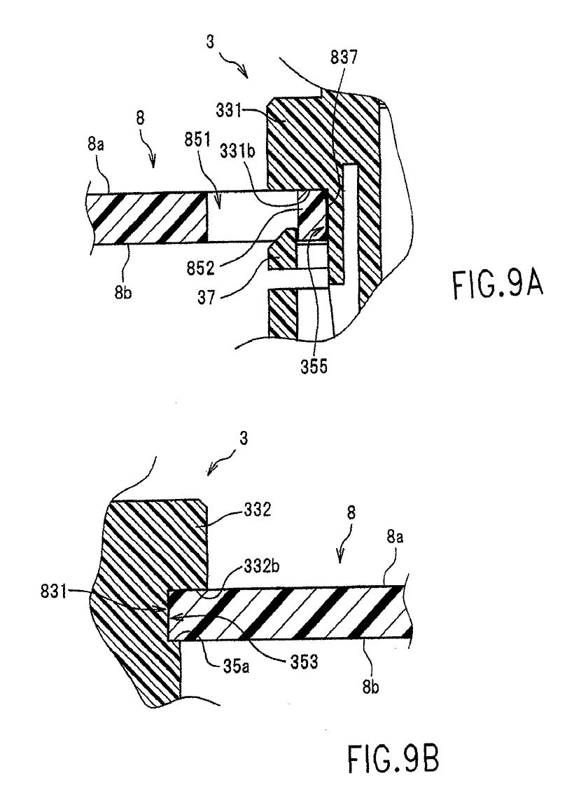

A state in which thick portions 331, 332 of adapter 3 run on front surface 8a of panel 8 is shown in partially enlarged cross sectional views of FIGS. 9A and 9B. As shown in FIG. 9A, rear surface 331b of thick portion 331 faces front surface 8a of panel 8. Also, the portions of corresponding surfaces 835, 837 in peripheral edge 83 of panel 8 are inserted into groove portion 355 defined below thick portion 331. The portions of corresponding surfaces 835, 837 are inserted up to the base end side of thick portion 331 projected with respect to groove 355. The portions of corresponding surfaces 835, 837 can abut against the bottom surface of groove portion 355, or can form gaps with the bottom surface of groove portion 355.

Likewise, as shown in FIG. 9B, rear surface 332b of thick portion 332 faces front surface 8a of panel 8, and rear surface 8b faces opposed surface 35a, which is an upper end surface of the portion that is recessed below side wall portion 35. Also, the portion of corresponding surface 833 in peripheral edge 83 is inserted into groove portions 353 defined between the lower portion of thick portion 332 and opposed surface 35a. The portion of corresponding surface 833 is inserted up to the base end side of thick portion 332, projected with respect to groove portions 353. The portion of corresponding surface 833 can abut against the bottom surface of groove portion 353, or can form gaps with the bottom surface of groove portion 353.

With the above configuration, when an external force is applied to adapter 3 downward (insertion direction of housing 2), rear surfaces 331b, 332b of thick portions 331, 332 of adapter 3 abut against front surface 8a to thereby regulate its movement. On the other hand, when the external force is applied to adapter 3 upward, opposed surfaces 35a, 351a abut against rear surface 8b of the panel to thereby regulate its movement. Also, because peripheral edge 83 reaches the base end sides of thick portions 331, 332 that are projected with respect to groove portions 353, 355, a stress that is developed on the base end sides of thick portions 331, 332 can be reduced. This is effective in the damage prevention.

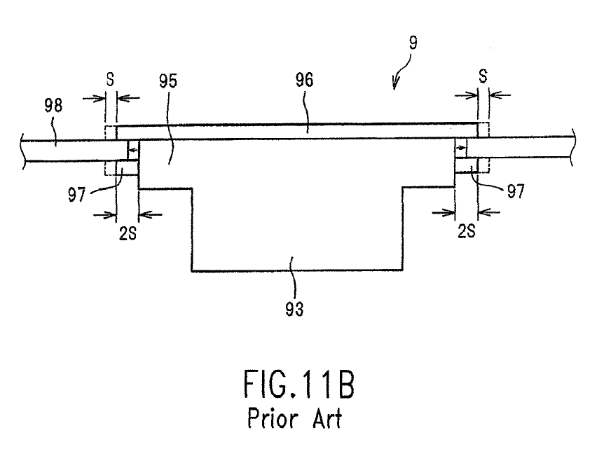

In order to illustrate the advantages of the Present Invention, described above, a schematic diagram of the cross-sectional structure of floating connector 1 is shown in FIG. 11A. For comparison, a schematic diagram of the cross-sectional structure of conventional floating connector 9, described above, 1 is shown in FIG. 11B. Housing main body 93 of conventional floating connector 9 is identical in width with front side main body portion 23 of housing 2 of the Present Invention. Also, rotating portion 95, larger in diameter than housing main body 93 in conventional floating connector 9, is identical in width with first projection portion 27 of housing 2 of the Present Invention. Also, retainer plate 96 and plate spring 97 in conventional floating connector 9, which radially spread from rotating portion 95, are represented by the minimum lengths in order to prevent rotating portion 95 from falling off. In fact, retainer plate 96 and plate spring 97 are longer than those shown in the drawings.

In floating connector 1 of the Present Invention, because front side main body portion 23, narrower in width than first projection portion 27, is floating within the through-hole of adapter 3, as fixed to panel 8, when it is assumed that a distance between the inner peripheral surface of the through-hole of adapter 3 and the outer side surface of front side main body portion 23 is floating amount S, a reach range of first projection portion 27 is a range obtained by adding floating amount S to the periphery of first projection portion 27 at the center position.

On the contrary, in conventional floating connector 9, because rotating portion 95, larger in diameter than housing main body 93, is floatably supported within the connector insertion hole of panel 98, retainer plate 96 and plate spring 97 radially spread from rotating portion 95. For that reason, when same floating amount S as that of floating connector 1 of the Present Invention is intended to be obtained, the minimum lengths of retainer plate 96 and plate spring 97 are twice as large as floating amount S. Further, when retainer plate 96 and plate spring 97 are floating together with rotating portion 95, a reach range of retainer plate 96 and plate spring 97 is a range obtained by adding floating amount S to the periphery of retainer plate 96 and plate spring 97 at the center position. Accordingly, when being considered on the basis of rotating portion 95, the reach range of retainer plate 96 and plate spring 97 are obtained by adding three times floating amount S to the periphery of rotating portion 95 at the center position. Thus, as described above, floating connector 1 of the Present Invention is capable of compactifying the reach range of the floating member as compared with conventional floating connector 9.

While a preferred embodiment of the Present Invention is shown and described, it is envisioned that those skilled in the art may devise various modifications without departing from the spirit and scope of the foregoing Description and the appended Claims.

What is claimed is:

1. A floating connector, comprising:
a housing;
an adapter, the adapter including a through-hole into which the housing is inserted;
a first projection portion, the first projection portion projecting laterally outward and abutting against a periphery of an opening of the through-hole; and
a second projection portion, the second projection portion being inserted into the through-hole with a stopper portion, the stopper portion being disposed within the through-hole;
wherein the first projection portion regulates a movement in an insertion direction, and the second projection portion regulates a movement in a direction opposite to the insertion direction.

2. A floating connector, comprising:
a housing;
a concave portion, the concave portion being formed on a front surface of the housing for housing a counterpart connector;
an insertion hole, the insertion hole being formed on a rear surface of the housing for inserting a terminal that is connected to the counterpart connector;
a first projection portion, the first projection portion projecting laterally outward from the concave portion;
a second projection portion, the second projection portion projecting laterally outward from the insertion hole;
an outer edge, the outer edge being positioned inward of the first projection portion;
an adapter that houses the housing, the adapter being formed with a through-hole that extends from the front surface side toward the rear surface side, in which the second projection portion is inserted from an opening on a front surface of the through-hole, the front surface of a periphery of the opening abutting against a rear surface of the first projection portion; and
a stopper portion, the stopper portion abutting against a front surface of the second projection portion;
wherein the first projection portion regulates a movement in an insertion direction, and the second projection portion regulated a movement in an opposite direction to the insertion direction.

3. The floating connector of claim 2 wherein the insertion hole is thinner than the concave portion.

4. The floating connector of claim 3, wherein the stopper portion is arranged laterally outward of the insertion hole.

5. The floating connector of claim 2, wherein the adapter includes projection portions, as part of an outer side surface which projects laterally outward of other parts, which have opposed surfaces directed toward the front surface.

6. The floating connector of claim 5, wherein the adapter is fitted to a panel in a state where a front surface of a periphery of a mounting opening, defined in the panel, faces the opposed surfaces.

7. The floating connector of claim 6, wherein a peripheral edge of the mounting opening reaches a base end side of the projection portions.

8. The floating connector of claim 2, wherein the adapter includes projection portions, as part of an outer side surface which projects laterally outward of other parts, which have opposed surfaces directed toward a rear surface.

9. The floating connector of claim 8, wherein the adapter is fitted to a panel in a state where a front surface of a periphery of a mounting opening, defined in the panel, faces the opposed surfaces.

10. The floating connector of claim 9, wherein a peripheral edge of the mounting opening reaches a base end side of the projection portions.

11. The floating connector of claim 2, wherein the rear surface of the first projection portion of the housing, and the front surface of a periphery of the opening of the adapter which faces the rear surface, are formed with a protrusion on one of the front surface and the rear surface.

12. The floating connector of claim 11, further comprising a hole portion, which is larger laterally than the protrusion, into which the protrusion is inserted on another one of the front surface and the rear surface.

13. The floating connector of claim 12, wherein lateral movement of the housing is regulated when the protrusion abuts against an inner wall of the hole portion.

14. The floating connector of claim 2, wherein at least a part of the front surface of the concave portion, which is formed in the housing, spreads toward the front surface side up to a region including at least a part of a base end side of the first projection portion.
